(19) United States
(12) Patent Application Publication
(10) Pub. No.: US 2011/0082698 A1
(43) Pub. Date: Apr. 7, 2011

(54) Devices, Systems and Methods for Improving and Adjusting Communication

(76) Inventor: Zev Rosenthal, East Hampton, NY (US)

(21) Appl. No.: 12/896,187

(22) Filed: Oct. 1, 2010

Related U.S. Application Data
(60) Provisional application No. 61/247,826, filed on Oct. 1, 2009.
(60) Provisional application No. 61/249,124, filed on Oct. 6, 2009.

(51) Int. Cl. G10L 21/00

(52) U.S. Cl. 704/270.1; 704/E21.001

(57) ABSTRACT

Devices, methods and systems for improving and adjusting voice volume and body movements during a performance are disclosed. Device embodiments may be configured with a processor, microphone, one or more movement sensors and at least a display or a speaker. The processor may include instructions configured to receive at least one of sound input from the microphone and movement data from the one or more accelerometers, generate one or more input levels corresponding to at least one of the sound input and movement data, compare the one or more generated input levels to one or more predefined input levels, associate the one or more predefined input levels with at least one of a color, text, graphic or audio file and present at least one of the color, text, graphic or audio file to a user of the device.

### CROSS-REFERENCE TO RELATED APPLICATIONS

The present application claims priority to U.S. Provisional Patent Application No. 61/247,826, filed on Oct. 1, 2009 and entitled “Method and Apparatus for Vocal Coaching” and U.S. Provisional Patent Application No. 61/249,124, filed on Oct. 6, 2009 and entitled “Method and Apparatus for Activity Monitoring During a Presentation/Performance,” the disclosures of which are incorporated herein by reference in their entirety.

### TECHNICAL FIELD

The subject matter described herein relates to monitoring, analyzing and providing feedback regarding vocal and physical movement characteristics of an individual during a performance.

### BACKGROUND

Developing the confidence and skills for effectively communicating, presenting and/or performing before a live audience or recording device can be critically important to an individual's professional development and success and/or a company's ability to survive and thrive in today's business environment. For individuals, having the ability to prepare for and deliver high-impact presentations or performances—whether it is a live event, such as an on-stage vocal performance, a mission-critical speech at a business meeting or an appearance at a press conference or media interview, or a recorded event, such as a television or radio program—can often lead to success and career advancement. The same holds true for many companies, as executives, senior leaders and other high-potential associates are often the voice and face of the company. Hiring and/or training individuals to deliver high-impact presentations and/or performances will cause a company to flourish in the digital age.

A performance by an individual is only as good as his or her audience perceives it to be. Audiences experience performances (live or recorded) primarily through the visual and auditory senses—what is seen and what is heard. Effective communication skills and performances thus include physical skills (e.g., gestures, stance and movement) to energize the message and increase audience attention and vocal skills (e.g., voice tone, pitch and pace) to capture audience attention, convey enthusiasm, avoid monotone delivery and project vocal energy.

These skills may be developed and honed in a variety of ways, including reading books, watching other presentations and performances, attending seminars and classes and personal coaching. In today's fast-paced, global business environment, real-time feedback and critique when practicing for a performance or “in-the-moment” coaching during an actual performance is critical to effectively developing communication skills in the digital age. However, individuals often do not have the luxury of a personal coach, nor are companies able to provide personal coaching or send their employees to seminars or classes.

### SUMMARY

In some embodiments described herein, a device may be configured to operate a software application program for improving a performance or adjusting communication during a performance. Device embodiments may include a processor, microphone, one or more movement sensors and at least one of a display and a speaker. The processor may include instructions operating thereon that are configured to receive at least one of sound input from the microphone and movement data from the one or more movement sensors, generate one or more input levels corresponding to at least one of the sound input and movement data, compare the one or more generated input levels to one or more predefined input levels, associate the one or more predefined input levels with at least one of a color, text, graphic or audio file and/or present at least one of the color, text, graphic or audio file to a user of the device. In some embodiments, the sound input may be the voice of the user and the movement data may be the physical movement of the body of the user. Device embodiments according to the present disclosure may be configured for use with a smartphone (e.g., an iPhone® or Android-based device), tablet computer (e.g., an iPad®) or other portable computing, audio and/or video device (e.g., an iPod® or Zune®).

In some device embodiments, the instructions may include providing feedback to the user that indicates too much vocal energy is being conveyed by the user when the input level corresponding to the sound input from the microphone is greater than a predefined level associated with a color, text, graphic or audio file that indicates too much vocal energy. The instructions may also include providing feedback that indicates too little vocal energy by the user when the input level corresponding to the sound input from the microphone is less than a predefined level associated with a color, text, graphic or audio file indicating too little vocal energy. Similarly, the instructions further comprise providing feedback that indicates too much physical movement energy when the input level corresponding to the movement data from the one or more movement sensors is greater than a predefined level associated with a color, text, graphic or audio file indicating too much physical movement energy. The instructions may also include providing feedback that indicates too little physical movement energy when the input level corresponding to the movement data from the one or more movement sensors is less than a predefined level associated with a color, text, graphic or audio file indicating too little physical movement energy. According to some embodiments, the instructions may include presenting the at least one of the color, text, graphic or audio file to a user of the device in real-time and/or, following the compare and associate steps, saving the results of these steps in memory for later review and analysis by a user.

Some embodiments of the present disclosure may be directed to a computer-implemented method for improving a performance or adjusting communication during a performance. The method may include providing a device having a processor, a microphone, one or more movement sensors and at least one of a display and a speaker, receiving at least one of sound input from the microphone and movement data from the one or more movement sensors, generating one or more input levels corresponding to at least one of the sound input and movement data, comparing the one or more generated input levels to one or more predefined input levels and/or associating the one or more predefined input levels with at least one of a color, text, graphic or audio file and/or presenting at least one of the color, text, graphic or audio file to a user of the device.

Other embodiments of the present disclosure may be specifically directed to a computer program product, tangibly embodied in a non-transitory machine-readable medium, and containing instructions to configure a data processing apparatus to perform the receiving, generating, comparing, associating and/or presenting operations described directly above.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a screen shot of a page presented at a user interface of a device that allows a user to select a coach, according to some embodiments of the present disclosure.

FIG. 2 shows a user using the vocal coach during a live performance, according to some embodiments of the present disclosure.

FIG. 3 shows a user using the vocal coach during a practice session, according to some embodiments of the present disclosure.

FIGS. 4a-4c show screen shots of a page presented at a user interface of a device providing a user with vocal performance feedback, according to some embodiments of the present disclosure.

FIG. 5 illustrates a process using the vocal coach to obtain vocal performance feedback, according to some embodiments of the present disclosure.

FIG. 6 shows a screen shot of a page presented at a user interface of a device providing a user with instructions for using the vocal coach, according to some embodiments of the present disclosure.

FIG. 7 shows a user using the energy coach during a live performance, according to some embodiments of the present disclosure.

FIG. 8 illustrates a process using the energy coach to obtain feedback regarding physical movement energy, according to some embodiments of the present disclosure.

FIG. 9 shows a screen shot of a page presented at a user interface of a device providing a user with instructions for using the energy coach, according to some embodiments of the present disclosure.

Like reference symbols in the various drawings indicate like elements.

### DETAILED DESCRIPTION

The subject matter described herein relates to devices, systems and methods for providing feedback to an individual regarding one or more aspects of his or her individual performance or presentation (e.g., a speech, a song, running a meeting or a public interview). Such feedback may be useful in helping an individual to develop and/or improve his or her communication skills when presenting or otherwise performing before a live audience and/or recording equipment. Some embodiments of the present disclosure may be directed to improving how one is perceived by an audience and/or by recording equipment during a live performance by detecting, analyzing and providing feedback regarding the vocal energy and/or physical movement energy conveyed by an individual during a performance. The feedback may be provided during a practice run of a performance and/or during an actual performance. In some embodiments, the feedback may be provided in real-time to allow an individual to adjust his vocal energy and/or physical movement energy “on-the-fly” during an actual performance. In some embodiments, feedback may be saved for later review and analysis.

The terms “presentation” and “performance” are used herein interchangeably to refer to any type of speaking, singing, acting, dancing or other activity that is done live before one or more persons (e.g., an audience) and/or recorded (e.g., via an audio and/or video recorder). In some embodiments, a performance may refer to a private recording session, for example, in a studio or at an individual's home. The terms “user,” “individual” and “presenter” are used herein interchangeably to refer to any person making use of the vocal coach and/or energy coach, in conjunction with any of the described device, system and/or method embodiments, for receiving feedback on one or more aspects of an individual's vocal energy and/or physical movement energy.

Embodiments of the present disclosure for detecting, analyzing and providing feedback to an individual regarding vocal energy and/or physical movement energy may be referred to herein as a “vocal coach” and an “energy coach,” respectively. Some embodiments of the “coaches” may be configured to provide real-time feedback, in-the-moment coaching, portability (e.g., mobile and/or handheld) and 24/7 one-on-one coaching. Some embodiments of the “coaches” may be configured to store some or all of the feedback for review by the user and/or a third party at a later time.

Embodiments may also include articles, videos, audio recordings and other multimedia content that provide tips and techniques to an individual relating to improving vocal energy and/or physical movement energy during a presentation. In some embodiments, these tips and techniques may be tailored to specific attributes or characteristics of an individual's current communication skill set and/or may be more general. Exemplary tips and techniques relating to improving vocal energy may include without limitation breathe from the diaphragm, use appropriate volume level, vary vocal tone (i.e., inflection), breathe often to increase vocal projection and match tone to meaning. Exemplary tips and techniques relating to improving physical movement energy may include without limitation using an appropriate stance, using appropriate gestures (e.g., gesturing from the shoulder, not the elbow and gesturing with hands above the waist), using an open palm, keeping both hands at the side of the body and conveying appropriate enthusiasm.

Some embodiments of the present disclosure may include a “visual coach,” which may be configured to provide tips and techniques regarding what an individual should avoid doing during a presentation or performance, including keeping hands out of the pockets, eliminating twitching of the hands and avoiding unnecessary tilting of the body.

According to some embodiments of the present disclosure, the vocal coach and/or energy coach may be configured as one or more application programs that may be implemented and/or operated by or in conjunction with a wide variety of devices and systems, including without limitation personal digital assistants, handheld mobile devices, desktop computers, laptop computers, servers, public announcement (“PA”) systems and any other device dedicated specifically to the functionality disclosed herein and/or having such functionality in combination with a limited number of other functions, such as a phone or media player). Some embodiments may be configured as a standalone wireless device configured to communicate with one or more other devices or systems. Some embodiments may be configured for wired communication with another computing device. Some embodiments may be particularly applicable to smartphones (e.g., an iPhone®) and could be readily designed as a smartphone application. In some embodiments, the vocal coach and energy coach may be part of the same application program.

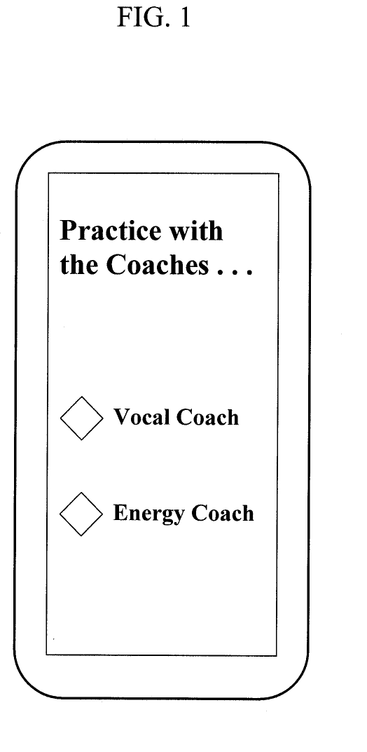

In operation, the application program(s) for the vocal coach and/or energy coach may be called by a user (e.g., by clicking on or otherwise selecting an icon) to perform vocal and/or energy coaching to the user during a practice and/or actual performance. Upon being called, the application program(s) may be configured to build a data model for a page to be presented at a user interface of a device or system of the user (e.g., an iPhone® or other mobile device). As shown in FIG. 1, the application program may be configured to build a page to be presented at the user interface of the user's device that provides a user with the option to select which coach it wishes to use. The page may be implemented as any type of electronic document including for example a hypertext markup language (“HTML”) page. The user interface may be implemented as any type of interface mechanism for a user, such as a web browser (which may include one or more plug-ins), a client application, a thin client and any other interface mechanism. In some embodiments, a user may select both coaches, such that the user receives feedback regarding his or her vocal energy and physical movement energy during the same performance. In such embodiments, the device or system may be held by the user and/or attached to the user's body to allow for measurement and collection of physical movement energy data and also be equipped with a microphone to provide detection and collection of vocal energy.

The vocal coach embodiments of the present disclosure may be directed to improving one or more aspects of a vocal performance in preparation for an upcoming performance or to adjusting one or more aspects of a vocal performance “on-the-fly” during an actual performance. Vocal performance aspects may include maintaining appropriate volume levels, varying vocal tone, increasing vocal projection and matching tone to meaning. For example, the vocal coach may provide feedback to a user that he or she is speaking too loudly or too softly either generally or at one or more specific places during a presentation based on an analysis of the vocal energy levels (e.g., voice volume) conveyed by a user during a performance. The feedback may be provided to a user by visual and/or auditory means to enable the user to develop and improve upon his or her vocal performance. The vocal coach may also, in some embodiments, inform a user regarding the tone and quality of his or her voice based on, for example, the frequency range and steadiness of the user's voice during a performance.

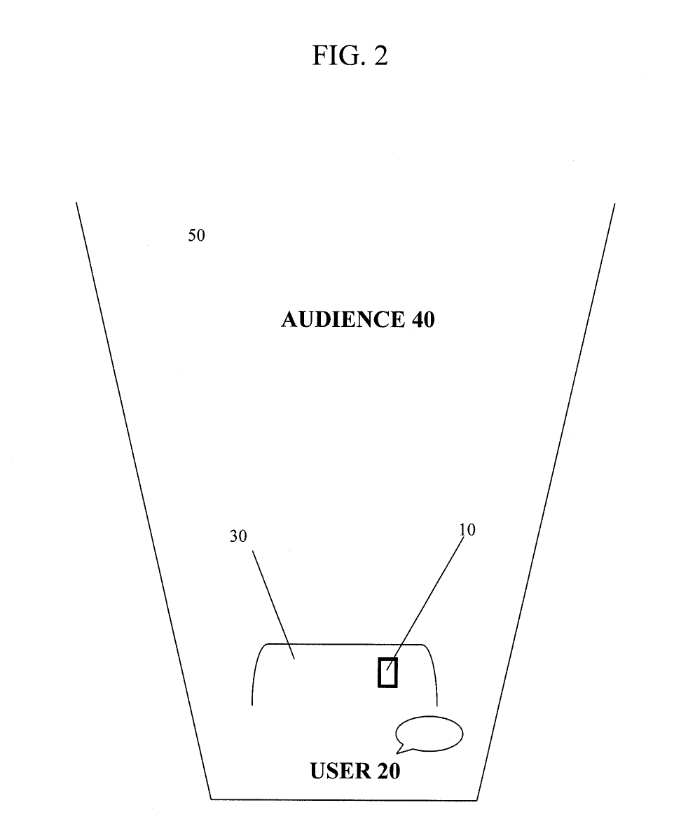

FIG. 2 shows a room 50 containing a basic user-audience situation in which a device 10 configured with a vocal coach application program may be used by a user 20 to improve and/or adjust his or her vocal performance during a presentation to an audience 40. The device 10 (e.g., a smartphone or other mobile device) may be positioned on a table, lectern or podium 30 between the user 20 and audience 40. In some embodiments, the device 10 may have a microphone (not shown) configured to detect and process the voice of user 20 and/or a separate microphone may be positioned near the user 20. The device 10 may provide feedback to user 20 based on the level, tone or other characteristics of the user's voice. The feedback may be conveyed to user 20 visually on a user interface (not shown) and/or orally through one or more speakers (not shown). The user interface and speakers may be part of device 10 or separate components in communication with device 10. In some embodiments, an earpiece or headphones may be connected to device 10 and worn by user 20 for hearing one or more oral instructions from the device 10. FIG. 2 depicts a live audience situation, such that device 10 and the vocal coach application contained thereon may be configured to provide real-time, “in-the-moment” feedback to user 20 during the performance to enable the user 20 to make “on-the-fly” vocal adjustments.

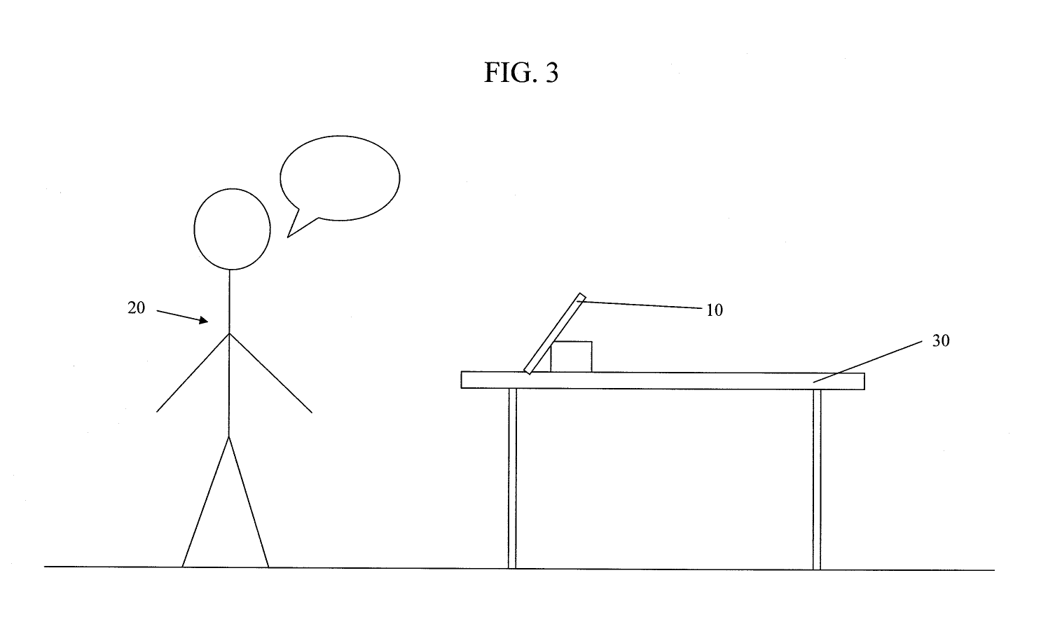

In some embodiments, the device 10 may be used in a practice setting, as shown in FIG. 3. In such embodiments, user 20 may set the device 10 on a table 30 or the like and practice his or her vocal performance and receive feedback from a vocal coach application program contained on device 10. In this setting, the vocal coach (and device 10) may be configured to provide real-time, “in-the-moment” feedback to user 20 to enable “on-the-fly” vocal adjustments or may be configured to store some or all of the vocal performance feedback for later review by user 20.

Embodiments of the vocal coach of the present disclosure may provide a user with feedback regarding his or her vocal performance by comparing the vocal energy of the user to one or more predefined levels. In some embodiments, predefined levels may correspond to a basic “low, medium or high” scale. For example, the vocal energy level perceived by the vocal coach may be denoted as “high” if the user spoke too loudly, “low” if the user spoke too softly or “medium” if the user spoke at an appropriate volume. In some embodiments, the predefined levels may be preset or preprogrammed into the vocal coach application program based on generally-accepted volume levels for a particular venue or event. In some embodiments, the predefined levels may be customized or calibrated in accordance with one or more characteristics, qualities or specifications relating to a user's voice (e.g., pitch and/or tone of a user's voice) and/or the acoustic properties of a particular venue. For example, setting one or more predefined levels may depend upon where a microphone for detecting the user's voice is placed relative to the user (e.g., sensitivity of the microphone). The distance between the user and the microphone may be any suitable or required distance including without limitation 100 feet, 50 feet, 25 feet or less (as shown in FIGS. 2 and 3), depending upon the size and/or acoustics of a particular room and whether amplification is being used. A user may also choose, in some embodiments, between different room settings included in the vocal coach application program including without limitation, “large auditorium,” “large conference room,” “small conference room” or “outside.” Other related settings may include “amplified” or “unamplified,” depending on the embodiment. In some embodiments, a user may also select what feedback should be given. A user may adjust or set such settings through a user interface on the device, which may include on-screen controls and/or mechanical controls, such as buttons or switches on the body of the device.

Device and/or system embodiments implementing a vocal coach application program according to the present disclosure may be positioned and/or arranged at one or more predetermined locations relative to the location of the user. For those embodiments containing the microphone and display screen in the same device (e.g., a smartphone or other mobile device), the microphone and display will be positioned at the same location and/or distance away from the user. For example, a user may place his or her smartphone on a table propped against a book. For system embodiments, different components may be positioned at various locations relative to the user. For example, one or more microphones may be placed at various distances from the user (e.g., one microphone on the user's podium and one microphone at the back of the room) and a separate display may be placed close to the user for easy visibility. In some embodiments, the display may be large and placed at a further distance (e.g., from 10 feet to 100 feet) from the user. For embodiments providing audio feedback (either alone or in conjunction with visual feedback), one or more speakers may be positioned at a distance audible to the user but not readily audible to the audience.

When a user speaks, one or more microphones may be configured to detect the user's voice as sound input. The microphone may transmit the sound input to a processor of a user's device (e.g., a smartphone or other mobile device) or system which analyzes the level of the sound input, including with respect to one or more predefined sound input levels. The processor in conjunction with the vocal coach application and other software and/or hardware components of the user's device may cause the creation of a web page comprising one or more visualizations relating to one or more vocal characteristics of the user to be presented at the user interface. In some embodiments, the vocal coach (and device) may be configured to detect and process the user's voice and display feedback substantially in real-time to allow the user to make “on-the-fly” or “in-the-moment” adjustments to one or more aspects (e.g., volume) of his or her voice. Some embodiments may be configured to record and/or forward the feedback for later use, viewing and/or analysis and, thus, need not be in real-time.

Embodiments of the vocal coach may be configured to associate the vocal energy level of a user's voice with one or more particular colors, shapes and/or patterns. For example, detection of a “high” level of vocal energy from a user may be associated with the color red or varying shades of that color depending on the specific vocal energy level detected relative to a predefined “high” level value. In some embodiments, detection of a “low” level of vocal energy from a user may be associated with the color yellow or varying shades of that color depending on the specific vocal energy level detected relative to a predefined “low” level value. In some embodiments, detection of a “medium” or adequate level of vocal energy from a user's voice may be associated with the color blue or green or varying shades thereof depending on the specific vocal energy level detected relative to a predefined “medium” level value.

Some embodiments of the vocal coach may be configured to associate a range of vocal energy levels received from a user with a particular volume of the user's voice. For example, if a vocal energy level is detected as being less than a predefined level, it may be associated with a volume level that is too soft and indicated as such to the user by any of the indication means described herein. Conversely, if a vocal energy level is detected as being greater than a predefined level, it may be associated with a volume level that is too loud and indicated as such to the user by any of the indication means described herein. In some embodiments, a vocal energy level may be identified as being between two predefined levels (e.g., a lower and upper threshold) and determined to be an appropriate volume.

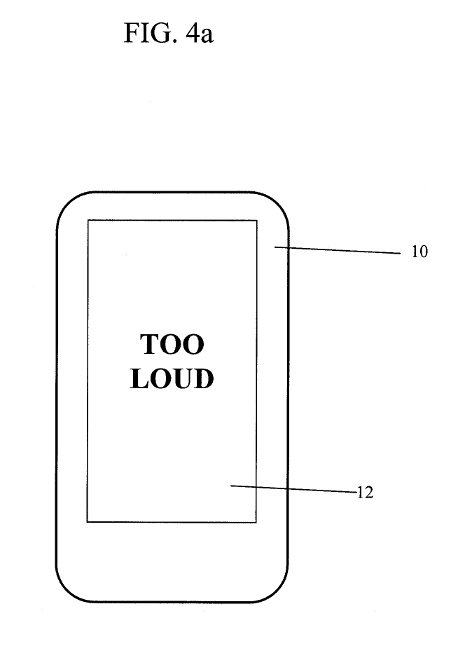

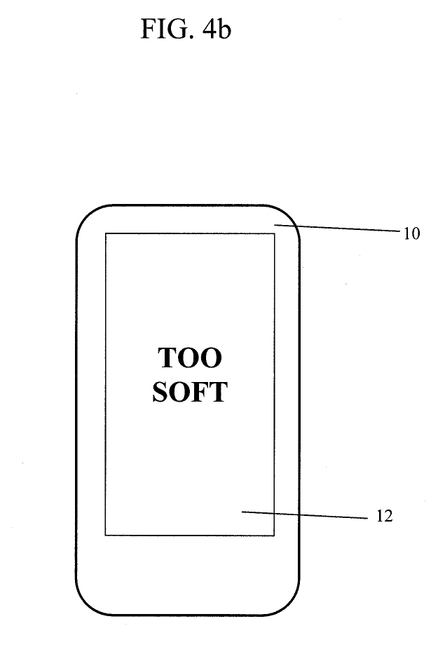

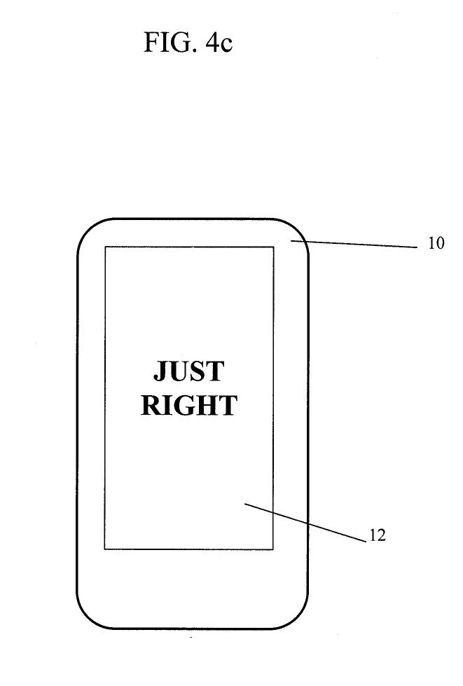

Some embodiments of the vocal coach may provide a user with feedback regarding his or her vocal energy using graphics and/or animations. For example, text indicating that a user is conveying too much or too little vocal energy may be displayed on the user interface 12 of the device 10 implementing the vocal coach, as shown in FIGS. 4a-4b. As shown in FIG. 4c, the vocal coach may cause the user interface 12 of device 10 to indicate that the user's volume is appropriate. In some embodiments, a graphic of a head with two hands covering the ears on the head may be used to inform a user that he or she is speaking too loudly. A graphic of a head with one hand cupped around one ear may be used to inform a user that he or she is speaking too softly. A graphic of a head with a smiling face may be used to inform a user that he or she is speaking at an appropriate volume. In some embodiments, any combination of color, text and/or graphics may be used.

In some embodiments, the vocal coach may be configured to activate an audio file to be played to inform the user about whether the vocal energy he or she is conveying is appropriate. For example, when a user is speaking too softly for a particular room and/or audience, the vocal coach may cause an audio file to be played which states, “You are speaking too softly.” When a user is speaking too loudly for a particular room and/or audience, the vocal coach may cause an audio file to be played which states, “You are speaking too loudly.” When a user is speaking at an appropriate volume, the vocal coach may cause an audio file to be played which states, “Your speaking volume is good.” The vocal coach may also cause one or more audio files to be played simultaneously with one or more visual indicators provided to the user (e.g., colors, text or graphics). The audio files may be played to a user through one or more speakers of a user's device or system or, in some embodiments, through an earpiece or headphones.

Some embodiments of the present disclosure may be configured to provide feedback only when certain conditions are met or occur. For example, embodiments of the vocal coach may be configured to provide a user with feedback when the user is speaking too loudly and/or too softly, but not when the user is speaking at an appropriate volume. In some embodiments, the vocal coach may be configured to give feedback only when the vocal energy level is at an adequate level or within an appropriate range.

Some embodiments of the vocal coach may be configured specifically for training a vocalist. To this end, embodiments of the vocal coach may analyze a vocalist's singing and provide feedback regarding vocal techniques, including adequate vibrato, appropriate phrasing and accuracy of pitches (e.g., singing in the correct key for a particular song).

In some embodiments, the vocal coach may be integrated into a system having a plurality of devices and/or components. For example, in some embodiments of the present disclosure, the vocal coach may be used by a third party operator (the “operator”) of a PA system comprising one or more microphones for amplifying the user's voice and/or speakers for projecting the user's voice to an audience. The operator may use the vocal coach to monitor, analyze and adjust the volume of the user's voice through the PA system in accordance with settings programmed into the vocal coach (e.g., settings unique to a particular audience). For example, an operator may connect an external device (e.g., a laptop computer or smartphone) to the PA system and/or have the vocal coach application integrated directly to the PA system (e.g., on the mixing board console) and observe on a user interface a red color when the user is speaking too loudly and/or a yellow color when the user is speaking too softly. In some embodiments, the operator may know in advance what type of audience is present and customize one or more of the predefined levels accordingly. For example, if the audience is generally one that enjoys softer volumes, the operator may set the vocal coach to display a red color at a lower voice volume.

Some embodiments of the present disclosure may be directed to methods of using the vocal coach to improve a vocal performance. Method embodiments may include providing a mobile device having at least one microphone for detecting the voice of a user, a processor and/or at least one user interface or speaker. Some method embodiments may further include receiving input from the microphone upon detecting a user's voice, as well as determining or generating a vocal energy level corresponding to the user's voice. The vocal energy level may be compared to at least one of a plurality predefined vocal energy levels and thereafter associated with at least one of a color, graphic, text or audio clip based on whether the detected vocal energy level is less than or greater than the one or more predefined levels. The corresponding color, graphic, text and/or audio clip may then be displayed and/or played to a user. In some embodiments, vocal performance data may be presented as raw data and/or graphs and charts summarizing the vocal performance data. The vocal performance data and any associated analyses may be stored on the user's device, a webpage, a server and/or a separate computer for later review.

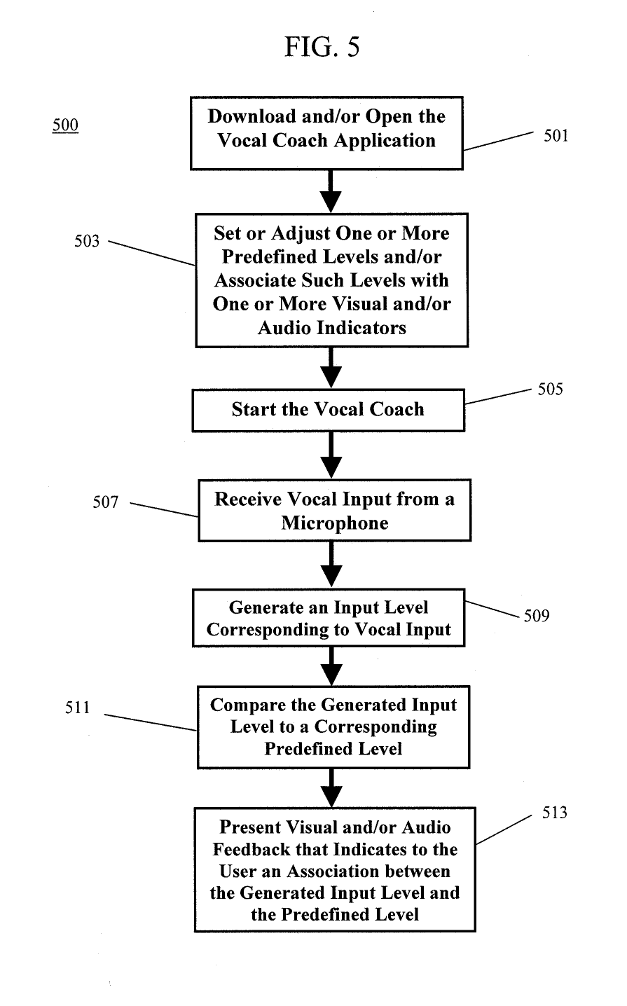

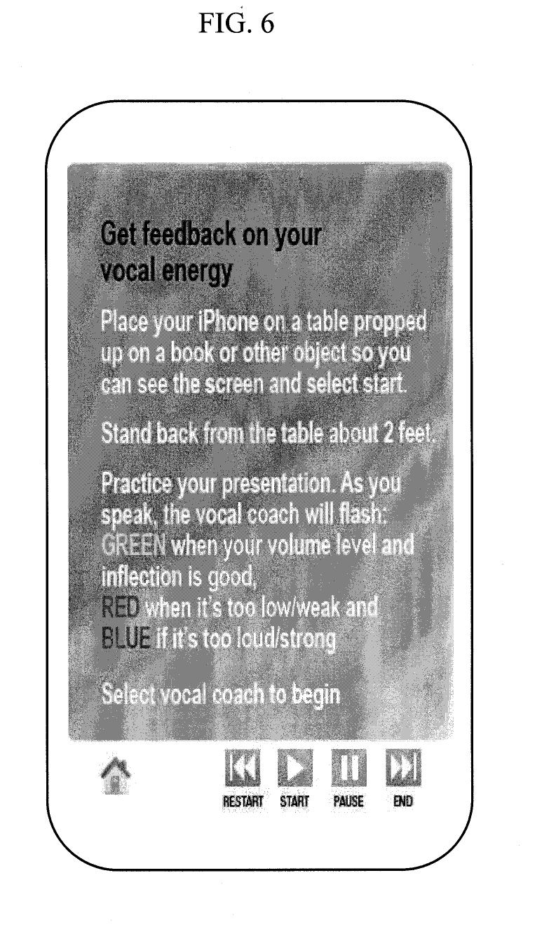

An exemplary methodology 500 for improving vocal performance (e.g., vocal energy levels) will now be described. An embodiment of a vocal coach application according to the present disclosure may be downloaded by the device (e.g., a smartphone) of a user and thereafter opened on the device, as indicated at step 501 in FIG. 5. In some embodiments, the processor of the device may work in conjunction with one or more algorithms of the vocal coach application to build an introductory instruction page, an example of which is shown in FIG. 6. At step 503, one or more predefined levels may be set or adjusted by the user and also associated with one or more visual or audio indicators, such as color, text, graphics or audio clips. For example, a predefined level established as an indicator of high vocal energy may be associated with the color “red,” the text “Too Loud” and/or an audio clip stating, “You are talking too loud,” such that when a user conveys vocal energy above this predefined level, one or more of the color, text or audio clip is presented to the user. This association may be preset in the vocal coach application as a preprogrammed algorithm or created by the user during step 503. When the “START” icon (shown in FIG. 6) is pressed at step 505, the vocal coaching application may begin collecting data. At this point, the user may begin practicing and/or giving his or her performance. At step 507, a microphone (e.g., on the device) may detect the user's voice and send continuous streams of vocal input to the processor of the device. During this time, a page may be presented at the user interface that states “Analyzing Vocal Performance” with a digital counter counting down the seconds. At step 509, the vocal coach and the processor may work in conjunction to generate an input level based on the stream of vocal input received from the microphone. The vocal coach and processor may then collaborate at step 511 to compare the generated input level to one or more of the predefined levels to determine whether the input level is above, below or the same as the predefined level. At step 513, the energy coach causes the user interface of the device to present a visual and/or audio indication as to the association between the user's vocal energy level relative to a predefined level.

Some embodiments of the vocal coach may be configured to periodically beep (e.g., every 30 seconds) during the performance to help the user keep track of time. The vocal coach may emit a double-beep when a certain predefined period of time (e.g., two minutes) has passed. Alternatively, a user may stop the vocal coach at any time during the presentation or performance to get feedback on his or her vocal performance. A user may also set the vocal coach to provide real-time feedback during the presentation to allow the user to adjust his vocal performance (e.g., vocal energy level) “on-the-fly” during the presentation.

The energy coach embodiments of the present disclosure may be directed to methods, devices and systems for providing an individual with feedback regarding aspects of his or her physical movement during a performance. Some embodiments may be directed to improving physical movement energy in preparing for a performance or adjusting physical movement energy “on-the-fly” during an actual performance. For example, device embodiments disclosed herein may be configured to detect and process the level of movement of an individual (e.g., the body and/or one or more of its parts) during a performance and provide feedback using visual and/or auditory means regarding movement energy (e.g., “too energetic,” “just right” or “too reserved”) to enable the individual to learn appropriate movement energy (e.g., to assist the individual in keeping their physical movement within an appropriate range).

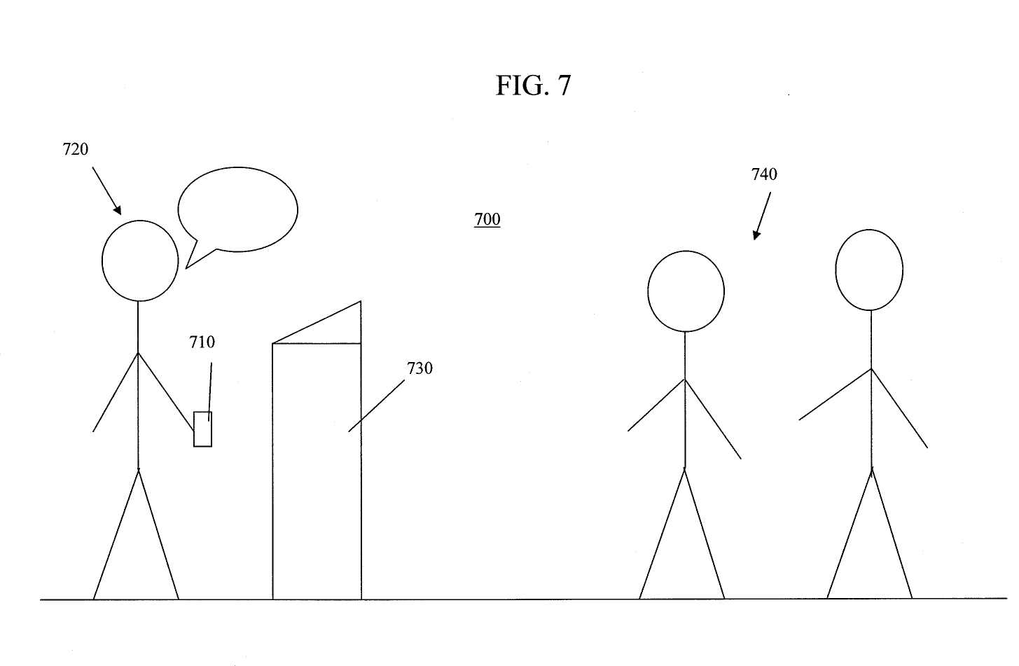

FIG. 7 shows a user-audience situation 700 in which a device 710 configured with an energy coach application program may be used by a user 720 to improve and/or adjust his or her physical movement energy during a presentation to an audience 740. The device 710 (e.g., a smartphone or other mobile device) may be held by user 720, affixed to the clothes of user 720 or placed in the pocket of user 720. In some embodiments, the device 710 may have one or more movement sensors (not shown) configured to detect and process physical movement energy (e.g., hand and/or arm movement) by the user 720. The device 710 may provide feedback (e.g., “too energetic,” “just right” or “too reserved”) to user 720 based on the level of physical movement by the user. The feedback may be conveyed to user 720 visually on a user interface (not shown) and/or orally through one or more speakers (not shown). The user interface and speakers may be part of device 710 or separate components in communication with device 710. In some embodiments, an earpiece or headphones may be connected to device 710 and worn by user 720 for hearing one or more oral instructions from the device 710. FIG. 2 depicts a live audience situation, such that device 710 and the energy coach application contained thereon may be configured to provide real-time, “in-the-moment” feedback to user 720 during the performance to enable the user 20 to make “on-the-fly” adjustments. As with the vocal coach (see FIG. 3), the energy coach may also be used in a practice setting as well.

Embodiments of the energy coach may detect the physical movement energy of an individual using a variety of suitable movement sensors, including without limitation accelerometers and/or GPS technology. For example, one or more accelerometers contained within a user's device implemented with the energy coach may be configured to measure the position of the device relative to at least one of three axes, x, y, and z. The accelerometer(s) may also be configured to measure the acceleration along one or more of these axes. In some embodiments, GPS location coordinates may be used in conjunction with the one or more accelerometers to determine a user's relative positioning and/or the positioning of the user's device. A variety of other components may also be involved in implementing and enabling the functionalities of the energy coach, including without limitation processors, various chipsets for communications and the like. Many current smartphones and similar mobile devices are configured with one or more of the aforementioned components and, thus, may be particularly useful at enabling and/or using various embodiments of the energy coach according to the present disclosure.

Device and system embodiments implementing an energy coach application program may be used to measure changes in position relative to at least one of the three axes, as well as a user's position (e.g., using GPS coordinates) and compare the measurements to predetermined values. The measurements taken by the movement sensors (e.g., one or more accelerometer(s)) may be processed and stored within memory located in the user's device and/or located remotely. Any one or more of these movement measurements may be tracked and/or recorded in the device as “movement data” and/or communicated (i.e., telemetered) to another device (e.g., a computer), one or more internet sites and/or one or more servers using wireless or wired data transfer (e.g., cellular, Wi-Fi and the like) by means well known in the art. To this end, movement data may be analyzed directly by the user's device or remotely by one or more other devices or systems. This analysis may involve measuring and processing various characteristics of a user's physical movement energy during a performance, including for example averages, extremes and any other known statistics. This analysis may be accomplished in part by the energy coach application program, in conjunction with other software and/or hardware on the user's device or on a separate device and/or internet site application.

In some embodiments, the energy coach may be configured to visually and/or orally present feedback relating to the movement data of the user. The feedback provided may be some version of the movement data subsequent to analysis and/or any corresponding results or conclusions derived from the movement data by the energy coach and/or some other application and algorithm. For example, a user interface of a handheld mobile device (e.g., a smartphone) or a laptop computer may present charts, graphs and spreadsheets depicting the movement data and any subsequent analysis to allow the user (or a reviewing third party) to determine whether the user was too active or not active enough for an effective presentation. The feedback may be presented to the user dynamically in real-time or may be saved and provided to the user at a later time for review and analysis.

The feedback provided by the energy coach may be based on comparisons to predetermined and/or standard movement criteria or values. For example, a physical movement energy level detected by the energy coach as being below a predefined level may correspond to “too little energy” for an effective presentation and indicated as such to the user. A physical movement energy level detected by the energy coach as being above a predefined level may correspond to “too much energy” for an effective presentation and indicated as such to the user. A user's energy may be considered “just right” if it corresponds to movement within a range of predefined levels. In some embodiments, the predefined levels may be preset or preprogrammed into the energy coach application program based on generally-accepted energy levels for a particular venue or event. In some embodiments, the predefined levels may be customized or calibrated in accordance with one or more characteristics, qualities or specifications relating to a user. A user may adjust or set the predefined levels via a user interface on the device, which may include on-screen controls and/or mechanical controls, such as buttons or switches on the body of the device. In some embodiments, a user may adjust the sensitivity of the movement sensors, including the one or more accelerometers and/or GPS system.

The feedback may be based on movement data collected over a predetermined period set by the user (e.g., 10 seconds, 30 seconds or one minute). In some embodiments, the feedback period may be for the entire performance, whereby a user may choose to receive feedback dynamically for the entire performance so that adjustments to his or her physical movement energy can be made “on-the-fly.”

When a user moves, one or more movement sensors (e.g., accelerometer(s)) may be configured to detect and measure the user's physical movements as movement data. The movement sensors may transmit the movement data to a processor of a user's device (e.g., a smartphone or other mobile device) or system which analyzes the level of the movement data, including with respect to one or more predefined movement energy levels. The processor in conjunction with the energy coach application and other software and/or hardware components of the user's device may cause the creation of a web page comprising one or more visualizations relating to one or more energy characteristics of the user to be presented at the user interface. In some embodiments, the energy coach (and device) may be configured to detect and process the user's physical movement energy and display feedback substantially in real-time to allow the user to make “on-the-fly” or “in-the-moment” adjustments to one or more aspects of his or her physical movement energy. Some embodiments may be configured to record and/or forward the feedback for later use, viewing and/or analysis and, thus, need not be in real-time.

Embodiments of the energy coach may be configured to associate the physical movement energy level of a user with one or more particular colors, shapes and/or patterns. For example, detection of a “high” level of movement energy from a user may be associated with the color red or varying shades of that color depending on the specific energy level detected relative to a predefined “high” level value. In some embodiments, detection of a “low” level of movement energy from a user may be associated with the color yellow or varying shades of that color depending on the specific energy level detected relative to a predefined “low” level value. In some embodiments, detection of a “medium” or adequate level of movement energy from a user may be associated with the color blue or green or varying shades thereof depending on the specific energy level detected relative to a predefined “medium” level value. Some embodiments of the energy coach may provide a user with feedback regarding his or her physical movement energy using graphics and/or animations. For example, text indicating that a user is conveying “too much energy” or “too little energy” may be displayed on a user interface 712 of the device 710 shown in FIG. 7 (see, e.g., FIGS. 4a-4b). The energy coach may also cause the user interface 712 to indicate that the user's movement energy is “just right.” (see, e.g., FIG. 4c). In some embodiments, any combination of color, text and/or graphics may be used.

In some embodiments, the energy coach may be configured to activate an audio file to be played to inform the user about whether the energy he or she is conveying is appropriate. For example, when a user is not using enough movement energy for a particular audience, the energy coach may cause an audio file to be played which states, “Use more energy!” When a user is moving around and/or gesturing too much for a particular audience, the energy coach may cause an audio file to be played which states, “Too much energy!” When a user is conveying an appropriate amount of energy, the energy coach may cause an audio file to be played which states, “Your energy level is great!” The energy coach may also cause one or more audio files to be played simultaneously with one or more visual indicators provided to the user (e.g., colors, text or graphics). The audio files may be played to a user through one or more speakers of a user's device or system or, in some embodiments, through an earpiece or headphones.

Some embodiments of the present disclosure may be configured to provide feedback only when certain conditions are met or occur. For example, embodiments of the energy coach may be configured to provide a user with feedback when the user is conveying too much energy and/or not enough energy, but not when the user is conveying an appropriate amount of energy. In some embodiments, the energy coach may be configured to give feedback only when the energy level is at an adequate level or within an appropriate range.

Embodiments of the energy coach may be configured for use in a variety of contexts. For example, and as described above, the movement data detected, measured, processed and presented to a user may be useful in preparing to give a presentation or for making “on-the-fly” adjustments to one's physical movement energy during a presentation. Energy coach embodiments may also be configured for use by those in the entertainment industry, including without limitation singers, dancers, musicians, actors and comedians, for learning how to improve physical movement energy on-stage. Using any one or more of the embodiments described herein, a user may practice with the energy coach to obtain feedback on their energy level and learn how to keep their level of movement within an audience-appropriate range. In some embodiments, the energy coach may also be configured to assist in training an individual to walk, run and/or move correctly. For example, energy coach (and an implementing device) may be used with or in combination with physical therapy to help a user recover from an injury which has affected the user's ability to move, walk and/or run.

Accordingly, embodiments of the present disclosure may be directed to a presentation training aid comprising a handheld mobile device (e.g., a smartphone) configured to operate one or more software applications programs. The handheld mobile device may include a user interface, one or more speakers, a processor and one or more of an accelerometer and/or GPS chipset. The processor of the handheld mobile device may include instructions operating thereon configured to receive movement data from the one or more accelerometers and/or GPS chipset. The movement data may be processed and analyzed to generate an input level corresponding to movement of a user that is holding or wearing the device. In some embodiments, the handheld mobile device may compare the input level to at least one of a plurality predefined input levels (e.g., an established range of acceptable movement energy levels) and associate one or more of the plurality of predefined input levels with at least one of a color, graphic, text and audio clip. The movement data and results of analyzing the movement data may then be presented on the display screen in the form of a color, graphic or text and/or an audio file through the speaker.

Some embodiments of the present disclosure may be directed to methods of using the energy coach to improve and/or adjust physical movement energy. Method embodiments may include providing a mobile device having a processor, at least one movement sensor equipped with an accelerometer and/or a GPS chipset and at least a display or speaker. Some method embodiments may further include receiving movement data from the movement sensors upon sensing movement by a user and generating an input level corresponding to this movement data. The input level may be compared to at least one of a plurality of predefined input levels and thereafter associated with at least one of a color, graphic, text or audio clip based on whether the input level is less than or greater than the one or more predefined input levels. The corresponding color, graphic, text and/or audio clip may then be displayed and/or played to a user. In some embodiments, movement data may be presented as raw data and/or graphs and charts summarizing a user's physical movement energy. The movement data and any associated analyses may be stored on the user's device, a webpage, a server and/or a separate computer for later review.

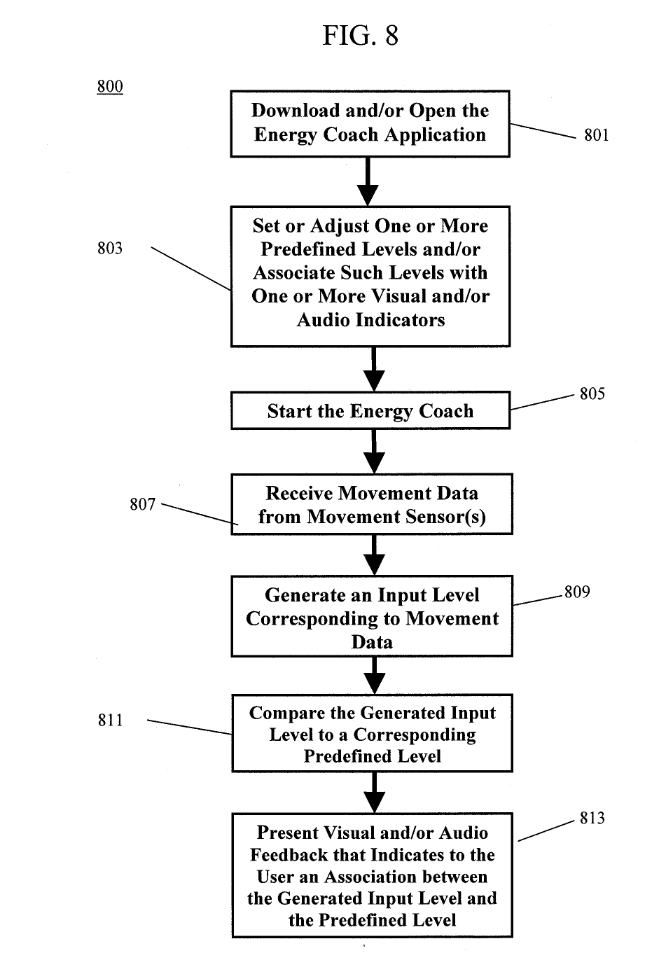

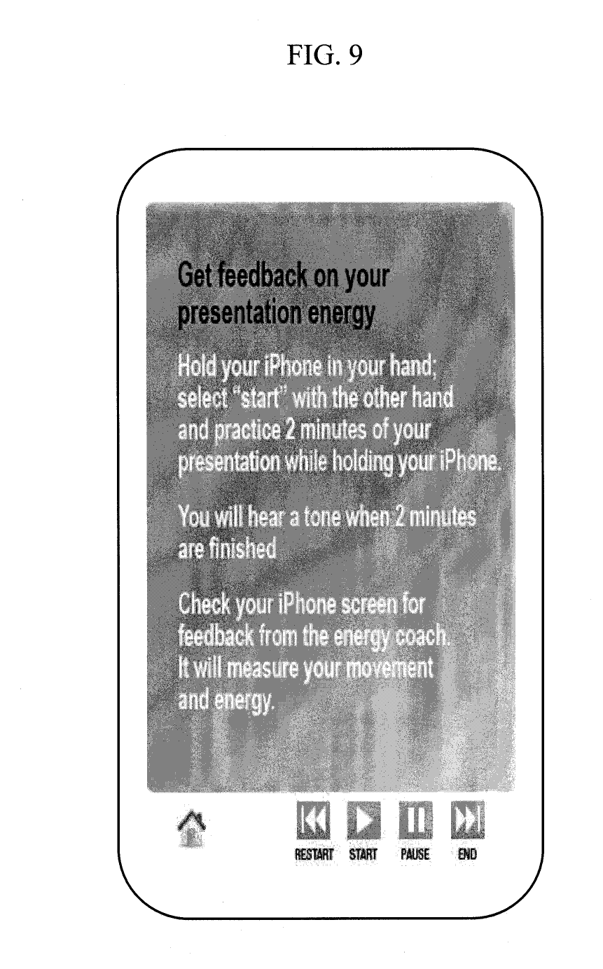

An exemplary methodology 800 for improving physical movement energy levels will now be described. An embodiment of an energy coach application according to the present disclosure may be downloaded by the device (e.g., a smartphone) of a user and thereafter opened on the device, as indicated at step 801 in FIG. 8. In some embodiments, the processor of the device may work in conjunction with one or more algorithms of the energy coach application to build an introductory instruction page, an example of which is shown in FIG. 9. At step 803, one or more predefined levels may be set or adjusted by the user and also associated with one or more visual or audio indicators, such as color, text, graphics or audio clips. For example, a predefined level established as an indicator of high movement energy may be associated with the color “red,” the text “Too Much Energy!” and/or an audio clip stating, “You are using too much energy,” such that when a user conveys energy above this predefined level, one or more of the color, text or audio clip is presented to the user. This association may be preset in the energy coach application as a preprogrammed algorithm or created by the user during step 803. When the “START” icon (shown in FIG. 9) is pressed at step 805, the energy coach application may begin collecting data and the user may begin practicing and/or giving his or her performance. At this point, the user should be holding the device in his or her hand or the device should be attached to the user's body or clothes to allow the one or more movement sensors to detect the user's physical movement energy. At step 807, one or more movement sensors (e.g., accelerometer(s)) may detect movement by the user and send continuous streams of movement data to the processor of the device. During this time, a page may be presented at the user interface that states “Analyzing Energy” with a digital counter counting down the seconds. At step 809, the energy coach and the processor may work in conjunction to generate an input level based on the stream of movement data received from the one or more movement sensors. The energy coach and processor may then collaborate at step 811 to compare the generated input level to one or more of the predefined levels to determine whether the input level is above, below or the same as the predefined level. At step 813, the energy coach causes the user interface of the device to present a visual and/or audio indication as to the association between the user's physical movement energy level relative to a predefined level.

Some embodiments of the energy coach may be configured to periodically beep (e.g., every 30 seconds) during the performance to help the user keep track of time. The energy coach may emit a double-beep when a certain predefined period of time (e.g., two minutes) has passed. Alternatively, a user may stop the energy coach at any time during the performance to get feedback on his or her energy level. A user may also set the energy coach to provide real-time feedback during the presentation to allow the user to adjust his energy level “on-the-fly” during the presentation.

The subject matter described herein may be embodied in systems, apparatus, methods, and/or articles depending on the desired configuration. Embodiments of the subject matter described herein may be realized in digital electronic circuitry, integrated circuitry, specially designed application specific integrated circuits (ASICs), computer hardware, firmware, software and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device and at least one output device.

These computer programs, which may also be referred to as programs, software, software applications, applications, components or code, may include without limitation machine instructions for a programmable processor. Embodiments of these computer programs may be implemented in a high-level procedural and/or object-oriented programming language and/or in assembly/machine language. As used herein, the term “machine-readable medium” refers to any computer program product, apparatus and/or device, including but not limited to magnetic discs, optical disks, memory and Programmable Logic Devices (PLDs), used to provide machine instructions and/or data to a programmable processor, including without limitation a machine-readable medium that receives machine instructions as a machine-readable signal. The machine-readable medium may store machine instructions non-transitorily, as would a non-transient solid state memory, magnetic hard drive or any equivalent storage medium. The machine-readable medium may alternatively or additionally store machine instructions in a transient manner, as would, for example, a processor cache or other random access memory associated with one or more physical processor cores.

Processors suitable for the execution of a computer program include, by way of example, both general and special purpose microprocessors and any one or more processors of any kind of digital computer. Generally, a processor will receive instructions and data from read-only memory (ROM), random access memory (RAM) or both. The essential elements of a computer are a processor for executing instructions and one or more memory devices for storing instructions and data. Generally, a computer will also include, or be operatively coupled to receive data from and/or transfer data to one or more mass storage devices for storing data, e.g., magnetic, magneto-optical disks or optical disks. Media suitable for embodying computer program instructions and data include all forms of volatile (e.g., RAM) or non-volatile memory, including by way of example only semiconductor memory devices (e.g., EPROM, EEPROM and flash memory devices), magnetic disks (e.g., internal hard disks or removable disks), magneto-optical disks and CD-ROM and DVD-ROM disks. The processor and the memory can be supplemented by, or incorporated in, special purpose logic circuitry. Data and/or computer program instructions may be stored locally or transmitted by cellular and/or Wi-Fi radio for storage on a network or other remote storage device.

To provide for interaction with a user, the subject matter described herein may be implemented on a computer having a display device, such as for example a cathode ray tube (CRT) or a liquid crystal display (LCD) monitor for displaying information to the user. The computer may also have a keyboard and/or pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback or tactile feedback. Similarly, input from the user to the computer may be received in any form, including but not limited to visual, auditory or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user may interact with an implementation of the subject matter described herein, or any combination of such back-end, middleware, or front-end components. The components of the system may be interconnected by any form or medium of digital data communication, such as for example a communication network. Examples of communication networks include, but are not limited to, a local area network (“LAN”), a wide area network (“WAN”) and/or the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The embodiments set forth in the foregoing description do not represent all embodiments of all inventions consistent with the subject matter described herein. Instead, they are merely some examples consistent with aspects related to the described subject matter and inventions thereof. Although a few variations have been described in detail above, other modifications or additions are possible. In particular, further features and/or variations may be provided in addition to those set forth herein. For example, the embodiments described above may be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other embodiments may be within the scope of the appended claims.

What is claimed is:

1. A device configured to operate a software application program for improving a performance or adjusting communication during a performance, the device comprising:
a processor;
a microphone;
one or more movement sensors; and
at least one of a display and a speaker, wherein:
the processor includes instructions operating thereon configured to:
receive at least one of sound input from the microphone and movement data from the one or more movement sensors;
generate one or more input levels corresponding to at least one of the sound input and movement data;
compare the one or more generated input levels to one or more predefined input levels;
associate the one or more predefined input levels with at least one of a color, text, graphic or audio file; and
present at least one of the color, text, graphic or audio file to a user of the device.

2. The device according to claim 1, wherein the sound input comprises the vocal energy of the user and the movement data comprises measurements of physical movement of the body of the user.

3. The device according to claim 1, wherein the instructions further comprise providing feedback to the user that indicates too much vocal energy when the input level corresponding to the sound input from the microphone is greater than a predefined level associated with a color, text, graphic or audio file that indicates too much vocal energy.

4. The device according to claim 3, wherein the instructions further comprise providing feedback that indicates too little vocal energy when the input level corresponding to the sound input from the microphone is less than a predefined level associated with a color, text, graphic or audio file indicating too little vocal energy.

5. The device according to claim 1, wherein the instructions further comprise providing feedback that indicates too much physical movement energy when the input level corresponding to the movement data from the one or more movement sensors is greater than a predefined level associated with a color, text, graphic or audio file indicating too much physical movement energy.

6. The device according to claim 5, wherein the instructions further comprise providing feedback that indicates too little physical movement energy when the input level corresponding to the movement data from the one or more movement sensors is less than a predefined level associated with a color, text, graphic or audio file indicating too little physical movement energy.

7. The device according to claim 1, wherein the device is a smartphone.

8. The device according to claim 1, wherein the instructions further comprise presenting the at least one of the color, text, graphic or audio file to a user of the device in real-time.

9. The device according to claim 1, wherein data resulting from the compare and associate steps is saved in memory for later review by the user.

10. A computer-implemented method for improving a performance or adjusting communication during a performance, the method comprising:
providing a device having a processor, a microphone, one or more movement sensors and at least one of a display and a speaker;
receiving at least one of sound input from the microphone and movement data from the one or more movement sensors;
generating one or more input levels corresponding to at least one of the sound input and movement data;
comparing the one or more generated input levels to one or more predefined input levels;
associating the one or more predefined input levels with at least one of a color, text, graphic or audio file; and
presenting at least one of the color, text, graphic or audio file to a user of the device.

11. The method according to claim 10, wherein the sound input is the voice of the user and the movement data is the physical movement of the body of the user.

12. The method according to claim 10, wherein the presenting further comprises providing feedback to the user that indicates too much vocal energy when the input level corresponding to the sound input from the microphone is greater than a predefined level associated with a color, text, graphic or audio file that indicates too much vocal energy.

13. The method according to claim 12, wherein the presenting further comprises providing feedback that indicates too little vocal energy when the input level corresponding to the sound input from the microphone is less than a predefined level associated with a color, text, graphic or audio file indicating too little vocal energy.

14. The method according to claim 10, wherein the presenting further comprises providing feedback that indicates too much physical movement energy when the input level corresponding to the movement data from the one or more movement sensors is greater than a predefined level associated with a color, text, graphic or audio file indicating too much physical movement energy.

15. The method according to claim 14, wherein the presenting further comprises providing feedback that indicates too little physical movement energy when the input level corresponding to the movement data from the one or more movement sensors is less than a predefined level associated with a color, text, graphic or audio file indicating too little physical movement energy.

16. The method according to claim 10, wherein the device is a smartphone.

17. The method according to claim 10, wherein the presenting further comprises presenting the at least one of the color, text, graphic or audio file to a user of the device in real-time.

18. The method according to claim 10, wherein data resulting from the comparing and associating is saved in memory for later review by the user.

19. A computer program product, tangibly embodied in a non-transitory machine-readable medium, the computer program product containing instructions to configure a data processing apparatus to perform operations comprising:
receiving at least one of sound input from the microphone and movement data from the one or more movement sensors;
generating one or more input levels corresponding to at least one of the sound input and movement data;
comparing the one or more generated input levels to one or more predefined input levels;
associating the one or more predefined input levels with at least one of a color, text, graphic or audio file; and
presenting at least one of the color, text, graphic or audio file to a user of the device.

20. The computer program product of claim 19, wherein the computer software product is downloaded onto a smartphone and provides feedback to a user about voice volume and body movement.
